(19) United States
(12) Patent Application Publication
(10) Pub. No.: US 2018/0375730 A1
(43) Pub. Date: Dec. 27, 2018

(54) TECHNIQUE FOR VERIFICATION OF NEWTORK STATE AFTER DEVICE UPGRADES

(71) Applicant: Infinera Corporation, Sunnyvale, CA (US)

(72) Inventors: Madhukar Anand, Fremont, CA (US); Ramesh Subrahmaniam, Fremont, CA (US)

(73) Assignee: Infinera Corporation, Sunnyvale, CA (US)

(21) Appl. No.: 15/792,135

(22) Filed: Oct. 24, 2017

Related U.S. Application Data
(60) Provisional application No. 62/524,066, filed on Jun. 23, 2017.

(51) Int. Cl. H04L 12/24; H04L 12/26

(52) U.S. Cl. CPC H04L 41/0866; G06F 8/65; H04L 41/145; H04L 43/08

(57) ABSTRACT

A network device may receive first network configuration data that include pre-upgrade network information. The network device may then determine, based on the first network configuration data, at least one first network invariant. Based on the first network invariant, the network device may determine a first set of hash values indicating a pre-upgrade network state. The network device may receive second network configuration data that includes post-upgrade network information. The network device may then determine, based on the second network configuration data, at least one second network invariant. Based on the second network invariant, the network device may determine a second set of hash values indicating a post-upgrade network state. The network device may then compare the first set of hash values and the second set of hash values to verify an upgrade state of a network node associated with the at least one first and second network invariants.

### CROSS REFERENCE TO RELATED APPLICATION

This application claims the benefit of U.S. provisional application no. 62/524,066 which was filed on Jun. 23, 2017, which is/are incorporated by reference as if fully set forth herein.

### FIELD OF INVENTION

The disclosed embodiments generally relate to network device upgrades and more particularly, to verification of network state after device upgrade.

### BACKGROUND

Software (e.g., firmware, operating systems, applications, etc.) designed to operate in network devices (e.g., routers, hubs, switches, servers, etc.) needs to be upgraded periodically to improve its performance, reliability, and security. More importantly, networking vendors and operators must ensure that software upgrades are performed accurately as expected before they implement the changes in their network systems. Today, the verification of software upgrades in network devices involves a great deal of manual intervention. For example, network administrators manually monitor various parameters such as routing entries, protocol states, and flow statistics after the software upgrades. If there are failures or performance issues after the software upgrades, those are hard to be detected or isolated to debug given that increasingly more complex network devices are provisioned in networks of many interdependent devices. Thus, it would be desirable to have a method and apparatus that provides the verification of software upgrades that works with various network systems across various network layers and protocols, based on efficient checking of network parameters such as invariants.

### SUMMARY

A system, method, and/or apparatus are disclosed herein for providing verification of network state after device upgrades by a network device in a network. For example, a network device may receive first network configuration data that include pre-upgrade network information. Based on the first network configuration data, the network device may determine at least one first network invariant. The first network invariant may comprise at least one of a topological invariant, a database invariant, or a network property invariant. The network device may then determine, based on at least one first network invariant, a first set of hash values indicating a pre-upgrade network state associated with at least one first network invariant. The first set of hash values may include a link hash value, a nodal label hash value, a link label hash value, a node forwarding database hah value, and a network property hash value.

After a plurality of network nodes in the network are upgraded, the network device may receive second network configuration data that includes post-upgrade network information. Based on the second network configuration data, the network device may determine at least one second network invariant. Similar to the fist network invariant, the second network invariant may comprise at least one of a topological invariant, a database invariant, or a network property invariant. The network device may then determine, based on at least one second network invariant, a second set of hash values indicating a post-upgrade network state associated with at least one second network invariant. The second set of hash values may include a link hash value, a nodal label hash value, a link label hash value, a node forwarding database hah value, and a network property hash value.

Upon determining the first and second sets of hash values, the network device may compare the first set of hash values and the second set of hash values, thereby verifying an upgrade state of a network node associated with the first and second network invariants.

### BRIEF DESCRIPTION OF THE DRAWINGS

A more detailed understanding may be had from the following description, given by way of example in conjunction with the accompanying drawings wherein:

FIG. 1 is a system diagram illustrating an example topology in which one or more disclosed embodiments may be implemented;

FIG. 2 is a system diagram illustrating another example topology in which one or more disclosed embodiments may be implemented;

FIG. 3 is a diagram illustrating an example topology based on network layers in which one or more disclosed embodiments may be implemented;

FIG. 4 is a flow diagram illustrating an example procedure for providing the verification of upgrade state after network nodes are upgraded; and

FIG. 5 is a flow diagram illustrating an example procedure for providing the prognostic verification of upgrade state after network nodes are upgraded by simulation.

### DETAILED DESCRIPTION OF THE PREFERRED EMBODIMENTS

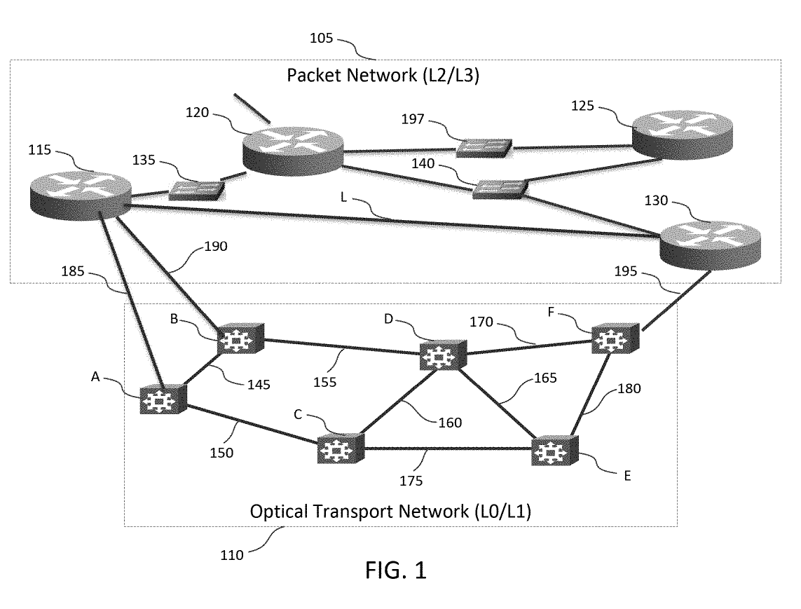

FIG. 1 is a system diagram showing an example topology 100 which illustrates aspects of topology aware network device upgrades. Topology 100 includes a packet network 105 and a transport network 110. Packet network 105 can be described as corresponding generally to a Datalink layer and/or Network layer of topology 100. Transport network 110 can be described as corresponding generally to an Analog Link layer and/or Digital Link layer of topology 100. The

Datalink layer and Network layer may be described as Layer 2 (L2) and Layer 3 (L3) of topology 100 respectively. The Analog Link layer and Digital Link layer may also be described as Layer 0 (L0) and Layer 1 (L1) of topology 100 respectively.

Packet network 105 includes packet aware routers 115, 120, 125, 130, 135, and 140, which are capable of packet switching. Packet aware routers are capable of decoding packets for routing. Routers 115, 120, 125, 130, 135, and 140 are in communication within packet network 105 over a number of packet links and nodes. For example, link L connects router 115 with router 130 in the packet domain. In the example of packet network 105, router 115 and router 130 are geographically separated and not directly connected—i.e., link L does not represent a direct or “one-hop” physical connection, but rather, represents a logical connection in the packet domain. At a lower level of abstraction, packets are transported between router 115 and router 130 over transport network 110, as optical signals, for example, that may be transmitted on each link, which may include one or more optical fibers.

Transport network 110 includes transport nodes A, B, C, D, E and F. It is noted that while transport network 110 is described with respect to optical technology for the sake of illustration, other transport technologies may be used (e.g., wired or radio frequency wireless). Transport nodes A, B, C, D, E and F can include any suitable optical transmission device, such as a fiber-optic repeater, optical receiver/transmitter, optical router, and/or other suitable device for transporting information over transport network 110, and typically do not decode packet headers for routing. Both router 115 and router 130, which do decode packets for routing, are connected to transport network 110, and information can take a number of paths from router 115 to packet aware router 130 through transport network 110. In another example, in the transport network 110, wavelength division multiplexing may be employed to combine multiple optical signals, each having a different wavelength, onto an optical fiber for transmission to a downstream transport node.

Routers 115 and 130 are edge devices of the transport network 110 and include circuitry configured to interface the packet network 105 with the transport network 110. Routers 115 and 130 can include, for example, packet-optical gateways (POGs) or packet-transport gateways (e.g., for non-optical transport implementations). Router 115 is in communication with transport node A via transport link 185. Router 115 is also in communication with transport node B via transport link 190. Router 130 is in communication with transport node F via transport link 195. It is noted that router 115 and 130 could be connected to optical nodes A, B, and F via a different kind of link (e.g., non-optical), or routers 115 and/or 130 could be co-located with or could include optical nodes A, B, and F respectively in other implementations.

Transport nodes A, B, C, D, E and F are in communication within transport network 110 over transport links 145, 150, 155, 160, 165, 170, 175, 180, 185, 190, and 195. Transport links 145, 150, 155, 160, 165, 170, 175, 180, 185, 190, and 195 can include any suitable optical medium for transmitting data, such as fiber optic cable. It is noted however that transport links 145, 150, 155, 160, 165, 170, 175, 180, 185, 190, and 195 may include any other suitable transport medium based on the technology of transport network 110 (e.g., electrically conductive cable and/or an air interface).

Viewed from the perspective of packet network 105, packet aware router 115 is only one logical hop away from packet aware router 130, via link L. However packets transmitted from router 115 to router 130 via logical link L are actually transported between router 115 and router 130 over several links of transport network 110. Transport network 110 does not decode headers for routing, and typically the details of transport network 110 are not accessible to routers and other devices in packet network 105.

An application transmitting packets over packet network 105, for example over a path which includes link L from router 115 to router 130, can leverage advertised segments (i.e. paths) to indicate a preference for certain transport characteristics such as latency, bandwidth, reliability, or security characteristics. For example, if a first path (nodes B, D, F via transport links 190, 155, 170, 195) has a particular low latency, and a second path (nodes A, C, E, F via transport links 185, 150, 175, 180, and 195) has a particular high reliability but higher latency, an edge router of the network can push (i.e., append) a label corresponding to the first path onto a packet to indicate a preference for the low latency path, or can push a label corresponding to the second path to indicate a preference for the high reliability path. The edge router may determine the suitable path characteristic using a deployment specific mechanism. For example, the edge router may receive this information from a network device 197, which may include a path computation element (PCE), a network controller or some embedded logic that receives topological updates about the network. A network controller can include a centralized entity configured to receive information about different transport paths and/or segments, and can use this information to create different paths having different characteristics. The network controller has knowledge of the topology of the network and can compute best paths through the network. A PCE can include a device that computes paths with constraints in the network. In either case, network device 197 can be centralized, having a view of the entire network administrative domain over which it has control. The network device 197 (e.g., edge router logic, PCE, or the network controller) may obtain the topological update information by participating in appropriate protocols that flood information about the topology of the network. Packet flooding is a computer network routing algorithm in which every incoming packet is sent through every outgoing link except the link on which it arrived. This label is used by the transport links 145, 150, 155, 160, 165, 170, 175, 180, 185, 190, and 195 to route the packet over the appropriate edges of optical network through transport network 110.

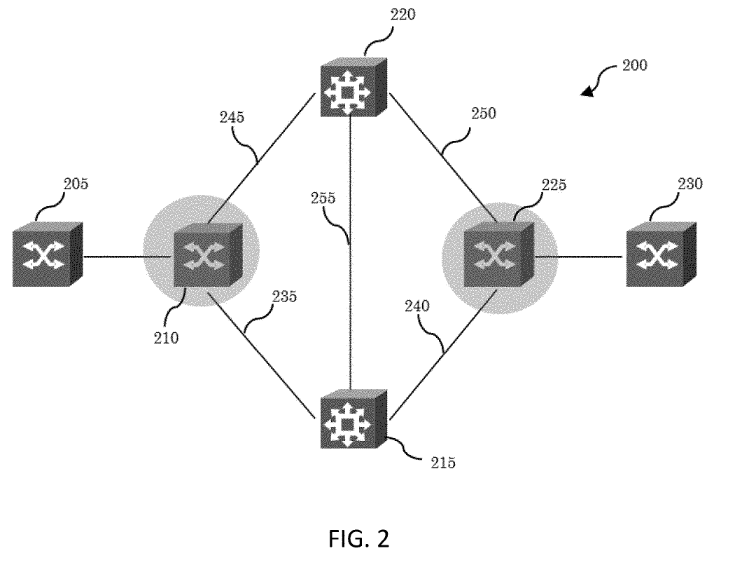

FIG. 2 is a system diagram of another example topology illustrating aspects of topology aware network device upgrades. Topology 200 is similar to topology 100, and includes a packet layer and a transport layer. Topology 200 includes packet nodes 205 and 230, and transport nodes 220 and 215. In topology 200, transport nodes 220 and 215 are optical routers, however other technologies can be used (e.g., wired or radio-frequency wireless). Packet nodes 205 and 230 are packet routers. Topology 200 also includes nodes 210 and 225, which are edge devices of a network which include circuitry configured to interface the packet layer with the transport layer, and which can be described as packet-optical gateways (POGs) or packet-transport gateways. Nodes 210 and 225 thus have features both of packet nodes and transport nodes.

Node 210 has a one-hop packet layer link with node 225 (not shown), however at the transport layer of abstraction, nodes 210 and 225 communicate via transport node 220, transport node 215, or both, over transport links 235, 240, 245, 250, and 255. Such communications may take one of several paths, or edges of optical network, across transport node 220, transport node 215, or both, over transport links 235, 240, 245, 250, and 255. In this example, a first path over transport links 245 and 250 via transport node 220 can be advertised to the packet domain by nodes 210 and 225. A second path over transport links 235 and 240 via transport node 215 can be advertised to the packet domain by nodes 210 and 225. A third path over transport links 245, 255, and 240 via transport nodes 220 and 215 in that order can be advertised to the packet domain by nodes 210 and 225. A fourth path over transport links 235, 255, and 250 via transport nodes 215 and 220 in that order can be advertised to the packet domain by nodes 210 and 225. A packet PCE can include these edges of optical network (i.e. paths) in specifying paths for reaching node 230 from node 205 based on service needs (e.g., a required latency or bandwidth for example) by including them in the appropriate segment lists or label stacks.

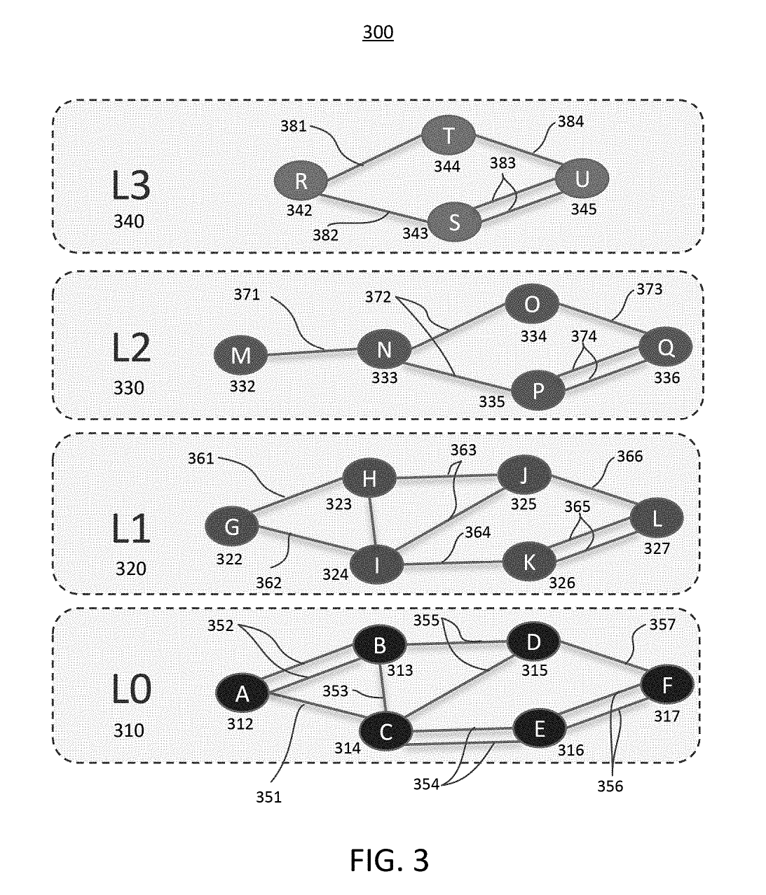

FIG. 3 illustrates an example topology 300 of network organization based on network layers. Topology 300 may comprise multiple network layers 310, 320, 330, 340 and network nodes 312-317, 322-327, 332-336, 342-345 that are interconnected each other via multiple network links 351-357, 361-366, 371-374, 381-384. A network layer 310, 320, 330, 340 serves the network layer above it and is served by the network layer below it. For example, a network layer 310, 320, 330, 340 that provides error-free communications across a network provides the path needed by applications above it, while it calls the next lower layer to send and receive packets that comprise the contents of that path. According to the Open Systems Interconnection model (OSI model), network layers 310, 320, 330, 340 may include seven layers: Physical Layer (Layer 1 320), Data Link Layer (Layer 2 330), Network Layer (Layer 3 340), Transport Layer (Layer 4), Session Layer (Layer 5), Presentation Layer (Layer 6), and Application Layer (Layer 7). However, network layers described herein are not limited to the OSI model. It may further include various network layers such as an Analog Link Layer as LO 310 and Digital Link Layer as L1 320 and combination thereof.

A network node 312-317, 322-327, 332-336, 342-345 is a connection point that can receive, create, store or send data along distributed network routes. Each network node 312-317, 322-327, 332-336, 342-345, whether it is an endpoint for data transmissions or a redistribution point, has either a programmed or engineered capability to recognize, process and forward transmissions to other network nodes. For example, in packet network 105 in FIG. 1, network nodes may include any network devices, such as routers 115, 120, 125, 130, 135, 140, a network device 197, a network controller, and the like. In transport network 110 in FIG. 1, a network node may include any network device, such as a fiber-optic repeater, optical receiver/transmitter, optical router, and/or other suitable device for transporting information over transport network 110.

A network link 351-357, 361-366, 371-374, 381-384 connects two network nodes at the same layer as connected by a horizontal connection in that layer or across different layers as connected by a vertical connection in those layers. For example, in FIG. 1, link L connects router 115 with router 130 in the packet domain by a horizontal connection in the same network layer (i.e. L2/L3 layer). Transport link 185 connects router 115 with transport node A by a vertical connection across two different layers (i.e. L2/L3 and L0/L1). As described above, a network link 351-357, 361-366, 371-374, 381-384 may include a logical connection or a physical connection depending on the network layers where data are transported.

As illustrated in FIG. 3, L0 layer 310 may refer to a physical layer, L1 layer 320 may refer to a data link layer, L2 layer 330 may refer to a network layer, and L3 layer 340 may refer to a transport layer. L0 layer 310 may include network nodes A 312, B 313, C 314, D 315, E 316, and F 317. L1 layer 320 may include network nodes G 322, H 323, I 324, J 325, K 326, and L 327. L2 layer 330 may include network nodes M 332, N 333, 0 334, P 335, and Q 336. L3 layer 340 may include network nodes R 342, S 343, T 344, and U 345. Each network node 312-317, 322-327, 332-336, 342-345 may be horizontally connected to one or more adjacent network nodes with one or more links within the same network layer as shown in FIG. 3. For example, a node R 342 may be horizontally connected with a node T 344 and a node S 343 within L3 340. Although it is not shown in FIG. 3, each network node 312-317, 322-327, 332-336, 342-345 may be vertically connected across network layers. For example, a node A 312 in L0 layer 310 may be vertically connected with a node G 322 in L1 layer 320. The node G 322 in L1 layer 320 may be vertically connected with a node M 332 in L2 layer 330. Similarly, the node M 332 in L2 layer 330 may be connected with a node R 342 in L3 layer 340.

As used herein, the terms “upgrade” and “update” may be used interchangeably throughout this disclosure to refer to a process to improve the functionality of network devices, to fix software errors, or to improve the network devices' overall operation and performance in part or in whole. As used herein, the terms “node” and “network node” may be used interchangeably throughout this disclosure to refer to a connection point that can receive, create, store or send data along distributed network routes. As used herein, the terms “link” and “network link” may be used interchangeably throughout this disclosure to refer to a connection between two or more nodes.

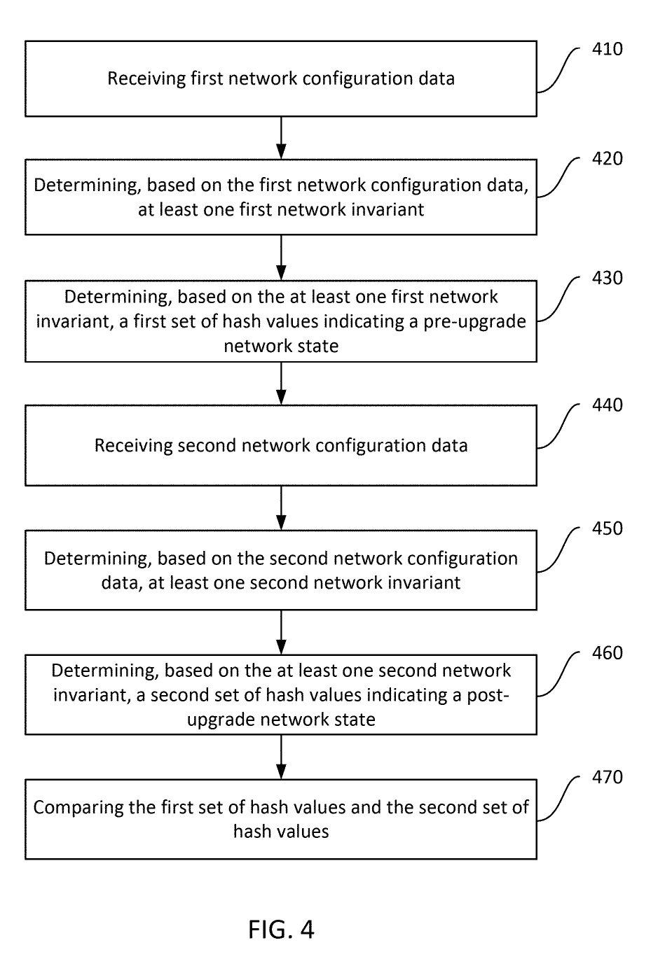

FIG. 4 illustrates an example procedure for providing the verification of upgrade state after network nodes are upgraded. Any type of network devices/nodes described in FIGS. 1-3 may provide this verification of upgrade state of network nodes. Examples of the network devices that can provide this verification procedure may include network interfaces, repeaters, hubs, bridges, switches, routers, modems, servers, or the like. It should be noted that switches, routers, modems or the like that run the verification of upgrade state may operate at multiple layers such as L0, L1, L2, and L3 layers. The network device that provides the verification of upgrade state may also receive/transmit data from/to multiple network nodes within a network or across multiple networks. For example, at step 410, a network device may receive, from a network management entity, first network configuration data that include information about network status and settings before network nodes are upgraded (i.e. pre-upgrade network information). The network management entity such as a network operator may have a view of the entire network administrative domain over which it has control. The network management entity may provide the network device pre-upgrade network information via wired or wireless connections between the network device and the network management entity. Examples of the network management entity may include a network operator, a network controller, a network administrator or the like. The pre-upgrade network information provided by the network management entity may include topology information, forwarding database, and network property information associated with network nodes that are not upgraded yet. The network property information may be latency, throughput, jitter, or the like. In some embodiments, the network device may query a network node or multiple network nodes to obtain forwarding database and network property information, or the like.

The verification of upgrade state may be implemented in any type of wired or wireless network with any type of network protocols. Examples of the networks may include Personal Area Network (PAN), Local Area Network (LAN), Metropolitan Area Network (MAN), Wide Area Network (WAN), Software-defined Network (SDN), non-SDN, Software-defined mobile networking (SDMN), Software-defined Wide Area Network (SD-WAN), Software-defined Local Area Network (SD- LAN), optical networks, centralized control networks, de-centralized control network or the like. Furthermore, network data center that is used to allow various network nodes to communicate among each other and with other data centers via fiber optic links may interconnects these networks and intra-data center networks.

At step 420, the network device may determine, based on the received network configuration data, at least one first network invariant. A network invariant used herein may refer to a network property or value of a network node that does not change after the network node is upgraded. For example, if a video streaming data is transmitted from a node A 312 to a node F 317 in FIG. 3, the node A 312 may choose a transmission path of A-B-D-F for its transmission of streaming data. This transmission path may be a network invariant for the node A 312. This means that the transmission path A-B-D-F must not be changed after the nodes A 312, B 313, D 315, F 317 are upgraded. In another example, a node J 325 in FIG. 3 are connected with nodes H 323, I 324, L 327 with links 363, 366, this link status of node J 325 (i.e. node and link connection information) may be a network invariant and must not change after the node J 325 is upgraded. After the node J 325 is upgraded, if the node J 325 is connected with different nodes other than nodes H 323, I 324, L 327 or includes different links other than the links 363, 366, this mismatch indicates that the upgrade process on the node J 325 has been performed improperly. Thus, it may conclude that the upgrade state of node J 325 is invalid. Example types and contents of the network invariant are shown in Table 1.

TABLE 1
Types and Contents of Network Invariant

| Type | Contents |
|---|---|
| Topological Invariant | Node, Link, Label |
| | Protocol |
| | Capability |
| Database Invariant | Routing Table |
| | Forwarding Table |
| | Flow Entries(OpenFlow) |
| Network Property | Latency |
| Invariant | Throughput |
| | Jitter |

Types of network invariant may include, but are not limited to, a topological invariant, database invariant, and network property invariant. A topological invariant used herein may refer to a network invariant that is related to a topology such as nodes, links, and labels (i.e. nodal and link). For example, a node N 333 in FIG. 3 includes three links 371, 372 to connect between a node M 332 and nodes 0 334 and P 335. These links information for the node N 333 may be a topological invariant because it must not change after the node N 333 is upgraded.

The topological invariant may also relate to protocols (including physical and logical protocols) and layers of a network. Examples of protocols may include, but are not limited to, Internet Protocol (IP), Transparent Interconnection of Lots of Links (TRILL), Internal Gateway Protocol (IGP), Border Gateway Protocol (BGP), Intermediate System to Intermediate System/Open Shortest Path First (IS-IS/OSPF). Examples of network layers may include, but are not limited to, Physical Layer (Layer 1), Data Link Layer (Layer 2), Network Layer (Layer 3), Transport Layer (Layer 4), Session Layer (Layer 5), Presentation Layer (Layer 6), Application Layer (Layer 7). In addition, the topological invariant may relate to the capability of nodes or links to establish connections between different networks and run multiple protocols under various networks. For example, the capability may be a redistribution capability of nodes or links to import and translate different protocols. Examples of capability may include, but are not limited to, Autonomous System Boundary Router (ASBR), Area Border Router (ABR), Designated Router/Designate Forwarder (DR/DF), and Backup DR/DF (BDR/BDF). The topological invariant may also related to roles or functions of network nodes in a network. For example, a node H 323 in FIG. 3 may serve as a gateway to other network nodes. Examples of network nodes' functions include, but are not limited to, Bridge, Cloud storage gateway, Default Gateway, Network switch, Residential gateway, Router, Switch, Subnetwork.

A database invariant used herein may refer to a network invariant that is related to forwarding database in a network. The forwarding database may include, but are not limited to, a routing table, routing information base (RIB), forwarding table, flow entries, OpenFlow. A routing table is a data table stored in a router or a network node that lists the routes to particular network destinations. The routing table may be constructed by routing protocols during discovery procedure. Whenever a node needs to send data to another node on a network, it must first know (i.e. learn) where to send the data. If the node cannot directly connect to the destination node, it has to send it via other nodes along a proper route to the destination node. To figure out which routes might work, a node may send an IP packet to a gateway node, which then decides how to route the data to the correct destination. Each gateway node may need to keep track of which way to deliver various packages of data and provide this information to the node requesting the information. The node may store the routing table in memory. Once the node finished constructing a routing table, it may not be changed by the sole reason of the upgrade. This routing table information has to be consistent before and after in order to properly deliver data to the destination node.

It should be noted that the difference between a database invariant and a topological invariant is that the database invariant may be determined (i.e. learned) during the operation of a network service, but the topological invariant may be determined upon establishment of network service.

Lastly, a network property invariant used herein may refer to a network invariant that is related to an end-to-end network property across a network. Examples of the end-to-end network property may include, but are not limited to, latency, throughput, jitter, or the like. Network latency may be an expression of how much time it takes for a packet of data to get from one designated node to another designated node. In some cases, latency may be measured by sending a packet that is returned to the sender; the round-trip time is considered the latency. For example, in FIG. 3, if a node A 312 transmits a data packet to a node F 317 and it takes 50 milliseconds for the packet to reach the node F 317, after the node A 312 is upgraded, it must take 50 milliseconds for the node A 312 to transmit the same data packet to the node F 317. In other words, a network application running in the node A 312 should not see the difference before and after the upgrade of the node A 312. Since a view of the entire network administrative domain is needed, these types of network invariants may be available at a network management entity such as a network controller or a network operator.

At step 430, the network device may determine, based on the first network invariant, a first set of has values that indicates a pre-upgrade state of network nodes. The pre-upgrade states may refer to a status of network nodes prior to a change (or upgrade) to software, firmware, and/or hardware configuration that are associated with the network nodes. Specifically, if the first network invariant is a type of topological invariant and related to a link, the network device may compute a link hash (LH) value by inputting link information into a hash function. The result of hash function may indicate a link state of a node before the node is upgraded. For example, in FIG. 3, before a node D 315 is upgraded, the node D 315 has three links 355, 357 which connects nodes B 313, C 314, and F 317. These connections may be link information for the node F 317 and may be input to the hash function to calculate the LH value. In an embodiment, the network device may produce a link hash value by ordering all the links for every node in a network based on unique identifiers and computing a Merkle Tree Hash or the like. The unique identifiers may be a numeral (e.g., IP address, MAC address, Multiple-protocol labels) or a string representing the node.

Similarly, if the first network invariant is a type of topological invariant and related to a node, the network device may compute a nodal label hash (NLH) value by inputting node information into a hash function. The result of hash function may indicate a nodal state of the node before the node is upgraded. For example, the network device may produce a nodal hash value by ordering all the labels for every node in a network using unique identifiers and computing a Merkle Tree Hash or the like. The unique identifiers may be a numeral (e.g., IP address, MAC address, Multip-protocol labels) or a string representing the node.

If the first network invariant is a type of topological invariant and related to a label, the network device may compute a link label hash (LLH) value by inputting label information into a hash function. The result of hash function may indicate a network label state before the node is upgraded. For example, the network device may determine a link label hash value by ordering all the labels for every link in a network using unique identifiers and computing a Merkle Tree Hash or the like. Similar to above, the unique identifiers may be a numeral (e.g., IP address, MAC address, Multip-protocol labels) or a string representing the node.

If the first network invariant is a type of database invariant and related to forwarding database information, the network device may compute a node forwarding database hash value (NFDH) by inputting forwarding database information into a hash function. The result of hash function may indicate a forwarding database state of a network node before the network node is upgraded. For example, in FIG. 3, a node C 314 may generate (i.e. learned) a routing table during discovery procedure that a node A 312 is the next station (i.e. next hop) to which the packet is to be sent. After this routing table information is input to the hash function, the result of hash function may indicate the state of routing table stored in the node C 314 before the node C 314 is upgraded. In an embodiment, the network device may determine a node forwarding database hash value (NFDH) by ordering all the forwarding entries for every node and forwarding database in a network using unique identifiers and computing a Merkle Tree Hash or the like. Similar to above, the unique identifiers may be a numeral (e.g., IP address, MAC address, Multiple-protocol labels) or a string representing the node.

Similarly, if the first network invariant is a type of network property invariant and related to network property information, the network device may compute a property hash (PH) value by inputting network property information into a hash function. The result of hash function may indicate a network property state across the network before the network is upgraded. For example, if a latency of node A 312 in L0 layer 310 (for transmitting a packet of data to a node F 317) is 50 milliseconds, the property hash (PH) value may indicate the latency of the node A 312 before the entire L0 layer 310 is upgraded. In an embodiment, the network device may determine a property hash value (PH) by ordering all the links and nodes as per network property-specific order, and computing a Merkle Tree Hash or the like. For example, the network device may maintain a PH value ordered by per-link latency for a flow from a source node to destination node.

In computing the above hash values (i.e. LH, NLH, LLH, NFDH, PH), the network device may use any type of hash functions. A hash function may refer to any function that can be used to map data of arbitrary size to data of fixed size. The values returned by a hash function are called hash values, hash codes, digests, or simply hashes. As used herein, the terms hash values, hash codes, digest, or simply hashes may be used interchangeably throughout this disclosure. Hash functions may be used in hash tables, which is a data structure to quickly locate a data record given its search key. Specifically, the hash function may be used to map the search key to a list; the index gives the place in the hash table where the corresponding record should be stored. Hash tables may also be used to implement associative arrays and dynamic sets. Examples of hash functions used herein may include, but are not limited to, Merkel hash, Bloom Filter hash, Inverse Bloom Filter hash, Trivial hash, Perfect hash, Minimal Perfect hashing, Rolling hash, Universal hashing.

After determining the above hash values (i.e. LH, NLH, LLH, NFDH, PH), at step 430, the network device may combine these hashes into a first set of hash values. This first set of hash values may indicate upgrade states associated with a topology, forwarding database, network property before upgrades (i.e. a pre-upgrade network state associated with the first network invariant). In some embodiment, the above hash values (i.e. LH, NLH, LLH, NFDH, PH) may be combined with any type of data structure. The examples of data structure that can be used with the first set of hash values may include, but are not limited to, array, linked list, stack, queue, heap, and tree.

At step 440, after at least one node in the network is upgraded, the network device may receive second network configuration data from a network management entity. The second network configuration data may include information about network status and settings after at least one network node are upgraded (i.e. post-upgrade network information). Similar to the first network configuration data, the second network configuration data may be provided by the network management entity via wired or wireless connections between the network device and the network management entity. However, the difference between the first and second configuration data is that the second network configuration data include information about post-upgrade states. The post-upgrade network information may also include topology information, forwarding database, and network property information after at least one network node in the network is upgraded. For example, in FIG. 3, when all of the nodes A 312, B 313, C 314, D 315, E 316, F 317 in L0 310 layer finished their upgrades, this information may be reported to a network management entity and the network management entity may generate second network configuration data about the L0 layer 310. The network device may then receive second network configuration data including post-upgrade network information of L0 310.

In an embodiment, a network device may receive second configuration data after all of the nodes in the entire network are upgraded. In this case, the network device may have post-upgrade network information for the entire network. In another embodiment, the network device may receive the second configuration data after some of the nodes are upgraded. For example, after all the nodes in a layer 2 are upgraded, the network device may obtain partial post-upgrade network information. The network device may also query a network node or multiple network nodes that finished its upgrade to obtain post-upgrade information. In this case, the post-upgrade information may be forwarding database, network property information, or the like.

At step 450, the network device may determine, based on the second network configuration data, at least one second network invariant. Similar to the first network invariant, types of the second network invariant may include, but are not limited to, a topological invariant, database invariant, network property invariant. As described above, the topological invariant for the second network invariant may relate to a nodes, links, labels, protocols, layers, and capabilities of nodes or links. For example, if a node J 325 in FIG. 3 runs on Internet Protocol (IP) in a network layer (i.e. L3 layer), the topological invariant associated with the node J's 325 protocol is IP. This protocol information must not be changed due to the node J's 325 upgrade. As described above, a database invariant for the second network invariant may include forwarding database such as a routing table, routing information base (RIB), forwarding table, flow entries, OpenFlow, or the like. Similarly, a network property invariant for the second network invariant may also relate to end-to-end network properties such as latency, throughput, jitter, or the like as described above.

After determining the second network invariant, at step 450, the network device may determine a second set of hash values that indicate a post-upgrade state of network nodes. Similar to the first set of hash values, if the second network invariant is a type of topological invariant and related to a link, the network device may compute a link hash' (LH') value by inputting link information into a hash function. The result of hash function may indicate a link state of a node after the node is upgraded. For example, in FIG. 3, after a node D 315 is upgraded, if the node D 315 lost a link 357 out of the three links 355, 357 and only has two links 355 remained (i.e. links connected to nodes B 313 and C 314), this status of links may be link information to be inserted into the hash function. The LH′ calculated based on this link information (i.e. two links 355) is different from the LH calculated based on link information without any loss (i.e. three links 355, 357). Similarly, if the second network invariant is a type of topological invariant and related to a node, the network device may compute a nodal label hash' (NLH') value by inputting node information into a hash function. The result of hash function may indicate a nodal state of the node after the node is upgraded. If the second network invariant is a type of topological invariant and related to a label, the network device may compute a link label hash' (LLH') value by inputting label information into a hash function. The result of hash function may indicate a network label state after the node is upgraded.

If the second network invariant is a type of database invariant and related to forwarding database information, the network device may compute a node forwarding database hash' (NFDH') value by inputting forwarding database information into a hash function. The result of hash function may indicate a forwarding database state of a network node after the network node is upgraded. For example, in FIG. 3, a node C 314 may have a routing table indicating that a node A 312 is the next station (i.e. next hop) to which the packet is to be sent before the node C 314 is upgraded. However, after the upgrade, the node C 314 may have a different routing table indicating that a node B 313 is the next station (i.e. next hop) to which the packet is to be sent. In this case, the different routing table in the upgraded node C 314 becomes the input of the hash function. Thus, the result of hash function NFDH' (associated with the second network invariant) is different from the result of hash function NFDH (associated with the first network invariant). Similarly, if the second network invariant is a type of network property invariant and related to network property information, the network device may compute a property hash' (PH') value by inputting network property information into a hash function. The result of hash function may indicate a network property state across the network after the network is upgraded.

In computing the above hash values associated with the second network invariant (i.e. LH', NLH', LLH', NFDH', PH'), the network device may use any type of hash functions as described above. The examples of hash functions used herein may include Merkel hash, Bloom Filter hash, Inverse Bloom Filter hash, Trivial hash, Perfect hash, Minimal Perfect hashing, Rolling hash, Universal hashing or the like.

After determining the above hash values (i.e. LH', NLH', LLH', NFDH', PH'), at step 460, the network device may combine these hashes into a second set of hash values. This second set of hash values may indicate post-upgrade states associated with a topology, forwarding database, network property after at least one node in the network is upgraded (i.e. a post-upgrade network state associated with the second network invariant). In some embodiments, the above hash values (i.e. LH', NLH', LLH', NFDH', PH') may be combined with any type of data structure such as an array linked list, stack, queue, heap, tree, or the like. The post-upgrade states may refer to a status of network nodes after a change (or upgrade) has been made to software, firmware, or hardware configuration that are associated with the network nodes.

After the first and second sets of hash values are determined, at step 470, the network device may initiate comparing the first set of hash values with the second set of hash values. The first set of hash values may be stored in the network device before network nodes are upgraded. The second set of hash values may be stored in the network device after at least one node is upgraded. In an embodiment, to compare the first and second sets of hash values, a network device may construct pre-upgrade and post-upgrade hash trees based on the first and second sets of hash values respectively. After the hash trees are constructed, the network device may implement equivalence check between the hash trees, for example using Merkle tree exchange algorithm, to highlight the point of hash mismatch.

Since each of the first and second network invariants is captured as a series of hashes (e.g., Merkle hash) in the first and second set of hash values, the network device may efficiently compare the contents of the first and second set of hash values using a hash tree. If there is any discrepancy between each element of the first and second set of hash values, the discrepancy may be reported to a network management entity or a network controller via wired or wireless network. For example, if the link hash value LH of the node F 317 in the first set of hash values is different from LH' of the node F 317 in the second set of has values after the node F 317 is upgraded, the network device may report the discrepancy to a network management entity to indicate that the upgrade state of node F 317 is invalid. Thus, the network management entity may recognize the location of error occurred during the upgrade process efficiently.

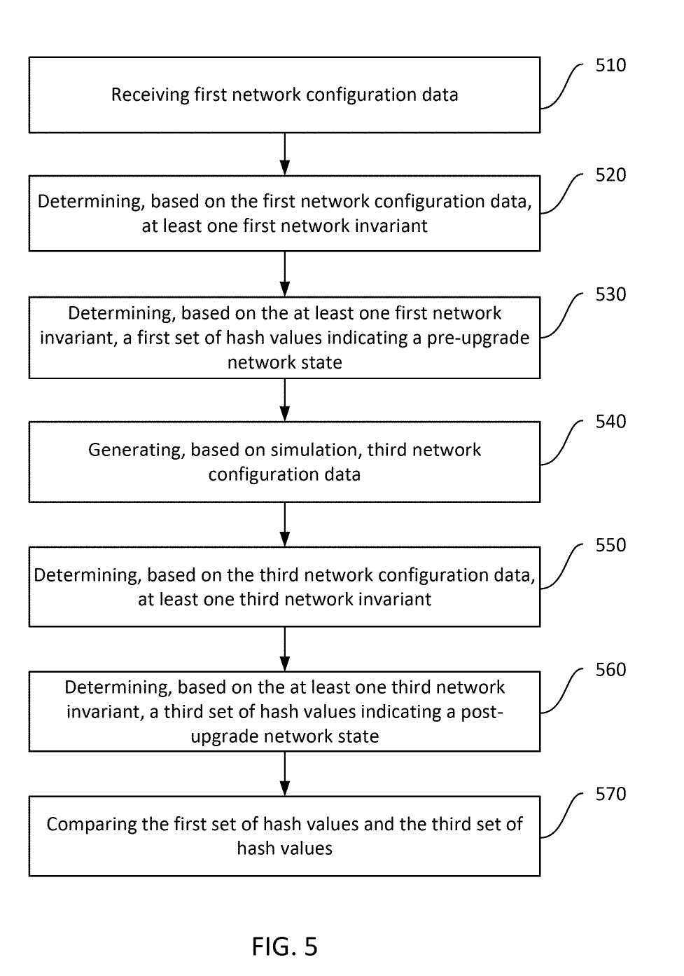

In an embodiment, a network device providing the verification of network upgrade may operate in a prognostic mode. FIG. 5 illustrates an example procedure for providing prognostic verification of upgrade state when a network device is operating in a prognostic mode. For example, at step 510, a network device may receive, from a network management entity, first network configuration data that include information about network status and settings before network nodes are upgraded (i.e. pre-upgrade network information). This pre-upgrade network information may include, but are not limited to, topology information, forwarding database, and network property information before network nodes are upgraded. At step 520, the network device may generate, based on the first network configuration data, at least one first network invariant. As described above, at step 530, the network device may determine, based on the first network invariant, a first set of has values that indicates a pre-upgrade state.

At step 540, the network device may simulate the upgrade process in each node in a network and generate third configuration data that include simulated information about network status and settings after the nodes are upgraded by simulation (i.e. simulated post-upgrade network information). Specifically, the network device may run a virtual machine or emulator inside the network device to simulate the upgrade process of software in each node in the network. After the upgrade process is simulated, the network device may generate a third network configuration data based on the simulation result. In some embodiments, each node may run a virtual machine or emulator to perform the simulated upgrade process internally. After the simulated upgrade process, each node may report its upgrade result to a network management entity or a network device running the verification of upgrade states. Based on the third configuration data, at step 550, the network device may determine at least one third network invariant. Similar to the first network invariant, types of the third network invariant may include a topological invariant, database invariant, or network property invariant.

At step 560, the network device may determine, based on the third network invariant, a third set of has values that indicates a simulated post-upgrade network state. After the first and third sets of hash values are determined, at step 570, the network device may compare the first set of hash values with the third set of hash values to indicate the point of failure as described above. When the network device is operating in a diagnostic mode, the network device may follow the example procedures described in FIG. 4.

In an embodiment, generating network invariants may be triggered by protocol convergence in various layers. Every layer has its own set of protocol and run it to communicate other nodes in a layer. Once all the nodes in the layer completed the upgrade process, that result may be informed to other nodes via the protocol on which the nodes are operating. Protocol convergence may refer to the state of a set of nodes (e.g. routers) that have completed its own upgrade process. The set of nodes may be defined in a layer. For example, for topological invariants, protocol convergence may refer to the state of a set of nodes that all the nodes in a layer has completed its upgrade process and each node is informed the completion via the protocol (e.g., peering has been re-established). In addition, upon protocol convergence, database of the node in the layer may be refreshed and the best paths may be computed. This database and path information may be pushed into a forwarding table. For database invariants, protocol convergence may refer to the state of a set of nodes that routing tables, forwarding tables, and flow entries in the nodes are all updated. For example, upon protocol convergence, a shortest path computation (SPF) is completed and this information is updated in the forwarding table or protocol database. For network property invariant, protocol convergence may refer to the state of a set of node that all the latency, throughput, and jitter information of the nodes are re-computed or measured after the update. It should be noted that the entire protocol in the network needs to be converged in order to trigger the network property invariant determination. This means that in order to update the latency, throughput, and jitter information, all the nodes in the entire network has to complete the upgrade process.

In another embodiment, in constructing hash trees to compare pre-upgrade set of hash values and post-upgrade set of hash values, any incremental hashing technique may be used in lieu of Merkle tree. In addition, if network devices that capture the state of pre-upgrade and post-upgrade are spread across multiple physical devices, then the multiple devices may use Tree Hash Exchange format to exchange upgrade information.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a transceiver for use in a router, hub, switch, server, WTRU, UE, terminal, base station, RNC, or any host network devices.

What is claimed is:

1. A method comprising:
receiving, at a network device, network configuration data for the plurality of network nodes, the network configuration data including at least one of network topology information, forwarding database information, or network property information;
determining, based on the network configuration data, the at least one network invariant;
determining, for each of a plurality of network nodes, a first set of hash values indicative of pre-upgrade states of the plurality of network nodes;
determining, for the each of the plurality of network nodes, a second set of hash values indicative of post-upgrade states of the plurality of network nodes; and
comparing the first set of hash values and the second set of hash values to verify an upgrade state for the each of the plurality of the network nodes;
determining the upgrade state invalid on a condition that at least one of the first set of hash values is different from at least one of the second set of hash values; and
transmitting the upgrade state of the each of the plurality of the network nodes to a network management entity,
wherein each of the first and second set of hash values is determined based on at least one network invariant indicative of a network property that does not change after a network node is upgraded.

2. The method of claim 1, wherein the at least one network invariant comprises at least one of a topological invariant, a database invariant, or a network property invariant.

3. The method of claim 2, wherein the topological invariant includes at least one of network node information, network link information, or network label information.

4. The method of claim 3, further comprising:
generating, based on the network link information, a link hash value indicating a pre-upgrade link state of a network node;
generating, based on the network node information, a nodal label hash value indicating a pre-upgrade nodal state of a network node; and
generating, based on the network label information, a link label hash value indicating a pre-upgrade label state of a network node.

5. The method of claim 2, wherein the database invariant includes routing database information of a network node.

6. The method of claim 5, further comprising: generating, based on the routing database information, a node forwarding database hash value indicating a pre-upgrade forward database state of the network node.

7. The method of claim 2, wherein the network property invariant includes at least one of latency information, throughput information, or jitter information for the plurality of network nodes.

8. The method of claim 7, further comprising: generating, based on the at least one of latency information, throughput information, or jitter information, a network property hash value indicating a pre-upgrade network property state of the plurality of network nodes.

9. The method of claim 1, wherein the pre-upgrade states indicate a status of the each of the plurality of network nodes prior to a change to a software, a firmware, or a hardware configuration that are associated with the plurality of network nodes, and the post-upgrade states indicate a status of the each of the plurality of network nodes after the change has been made to the software, the firmware, or the hardware configuration that are associated with the plurality of network nodes.

10. The method of claim 1, further comprising:
generating, at a network device, simulated network configuration data that include post-upgrade network information after the plurality of network nodes are upgraded by simulation;
determining, based on the simulated network configuration data, at least one second network invariant;
determining, for the each of the plurality of network nodes, a third set of hash values indicative of simulated post-upgrade states of the plurality of network nodes; and
comparing the first set of hash values and the third set of hash values to verify an upgrade state for the each of the plurality of the network node,
wherein each of the third set of has values is determined based on at least one second network invariant indicative of a network property that does not change after a network node is upgraded.

11. A network device comprising:
a receiver configured to receive network configuration data for the plurality of network nodes, the network configuration data including at least one of network topology information, forwarding database information, or network property information;
a processor configured to:
determine, based on the network configuration data, the at least one network invariant;
determine, for each of a plurality of network nodes, a first set of hash values indicative of pre-upgrade states of the plurality of network nodes;
determine, for the each of the plurality of network nodes, a second set of hash values indicative of post-upgrade states of the plurality of network nodes; and
compare the first set of hash values and the second set of hash values to verify an upgrade state for the each of the plurality of the network nodes; and
determine the upgrade state invalid on a condition that at least one of the first set of hash values is different from at least one of the second set of hash values; and
a transmitter configured to transmit the upgrade state of the each of the plurality of the network nodes to a network management entity,
wherein each of the first and second set of hash values is determined based on at least one network invariant indicative of a network property that does not change after a network node is upgraded.

12. The network device of claim 11, wherein the at least one network invariant comprises at least one of a topological invariant, a database invariant, or a network property invariant.

13. The network device of claim 12, wherein the topological invariant includes at least one of network node information, network link information, or network label information.

14. The network device of claim 13, wherein the processor is further configured to:
generate, based on the network link information, a link hash value indicating a pre-upgrade link state of a network node;
generate, based on the network node information, a nodal label hash value indicating a pre-upgrade nodal state of a network node; and
generate, based on the network label information, a link label hash value indicating a pre-upgrade label state of a network node.

15. The network device of claim 12, wherein the database invariant includes routing database information of a network node.

16. The network device of claim 15, wherein the processor is further configured to generate, based on the routing database information, a node forwarding database hash value indicating a pre-upgrade forward database state of the network node.

17. The network device of claim 12, wherein the network property invariant includes at least one of latency information, throughput information, or jitter information for the plurality of network nodes.

18. The network device of claim 17, wherein the processor is further configured to generate, based on the at least one of latency information, throughput information, or jitter information, a network property hash value indicating a pre-upgrade network property state of the plurality of network nodes.

19. The network device of claim 11, wherein the pre-upgrade states indicate a status of the each of the plurality of network nodes prior to a change to a software, a firmware, or a hardware configuration that are associated with the plurality of network nodes, and the post-upgrade states indicate a status of the each of the plurality of network nodes after the change has been made to the software, the firmware, or the hardware configuration that are associated with the plurality of network nodes.

20. The network device of claim 11, wherein the processor is further configured to:
generate simulated network configuration data that include post-upgrade network information after the plurality of network nodes are upgraded by simulation;
determine, based on the simulated network configuration data, at least one second network invariant;
determine, for the each of the plurality of network nodes, a third set of hash values indicative of simulated post-upgrade states of the plurality of network nodes; and
compare the first set of hash values and the third set of hash values to verify an upgrade state for the each of the plurality of the network node,
wherein each of the third set of has values is determined based on at least one second network invariant indicative of a network property that does not change after a network node is upgraded.
